(19) United States
(12) Patent Application Publication
(10) Pub. No.: US 2025/0344176 A1
(43) Pub. Date: Nov. 6, 2025

(54) TECHNIQUES RELATING TO VERIFIABLE LOCATION ESTIMATION OF A USER EQUIPMENT

(71) Applicant: Telefonaktiebolaget LM Ericsson (publ), Stockholm (SE)

(72) Inventors: Henrik NORMANN, Malmö (SE); Patrik SALMELA, Espoo (FI); Daniel BERGSTRÖM, Luleå (SE); Niklas LINDSKOG, Lund (SE); Peter ÖKVIST, Luleå (SE); Tommy ARNGREN, Södra Sunderbyn (SE)

(73) Assignee: Telefonaktiebolaget LM Ericsson (publ), Stockholm (SE)

(21) Appl. No.: 18/866,280

(22) PCT Filed: May 17, 2022
(86) PCT No.: PCT/EP2022/063241

§ 371 Date: Nov. 15, 2024

(51) Int. Cl. H04W 64/00; H04W 12/06; H04W 12/104

(52) U.S. Cl. CPC H04W 64/00; H04W 12/06; H04W 12/104

(57) ABSTRACT

There is provided techniques for verifiable location estimation of a UE. A method is performed by the UE. The method comprises determining a first estimate of the location of the UE. The method comprises providing a request to a serving mobile network for the serving mobile network to forward the first estimate to an AF entity. The method comprises receiving a signed token from the AF entity. The signed token comprises either a second estimate of the location of the UE as determined by the serving mobile network in response to an MT-LR having been triggered by the AF entity or the first estimate of the location. The method comprises storing the signed token.

### TECHNICAL FIELD

Embodiments presented herein relate to a method, a user equipment, a computer program, and a computer program product for verifiable location estimation of the user equipment. Further embodiments presented herein relate to a method, an application function entity, a computer program, and a computer program product for providing a verifiable location estimation of the user equipment. Further embodiments presented herein relate to a method, a verifying entity, a computer program, and a computer program product for verifying a location of the user equipment.

### BACKGROUND

Location services for fifth generation (5G) telecommunication systems are specified in 3GPP TS 23.273, entitled “5G System (5GS) Location Services (LCS); Stage 2”, version 17.4.0. Location services can be used by a user equipment (UE) served by a network to either by itself estimate its location or by the network, or an external entity operatively connected to the UE via the network, to estimate the location of the UE. The request for estimating the location of the UE might be triggered according to different aspects, such as on a regular basis, when the UE enters a certain area, or based on distance from the previous measurement.

In the aforementioned document 3GPP TS 23.273 is further specified different ways in which the location of the UE can be estimated. In particular, it is specified that a target UE may support positioning according to four different modes. These four modes are briefly summarized next.

In UE assisted mode the UE obtains location measurements and sends the measurements to another entity (e.g., a Location Management Function, LMF) to compute the location of the UE.

In UE based mode the UE obtains location measurements and computes a location estimate making use of assistance data provided by serving Public Land Mobile Network, PLMN).

In standalone mode the UE obtains location measurements and computes a location estimate without making use of assistance data provided by the serving PLMN.

In network based mode the serving network (such as a PLMN) obtains location measurements of signals transmitted by the target UE and computes a location estimate from the location measurements.

The first three modes might be regarded as examples of Mobile Originated Location Requests (MO-LR) whereas the last mode might be regarded as an example of a Mobile Terminated Location Request (MT-LR).

The transmission of UE signals for the network-based mode may or may not be transparent to the UE. That is, the UE might not even be aware of that its transmitted signals are used by the PLMN to estimate the location of the UE.

US 2020/0229069 A1 provides one example of how LCS can be used. In more detail, in US 2020/0229069 A1 is disclosed a method for providing location based communication services in a wireless communication system. The method focuses on deciding the altitude of the UE, which can be realized with LCS. The purpose is to allow for the network to adjust its transmission resources so as to provide high quality connectivity for UEs (e.g., so-called drones) operating at non-ordinary altitudes.

While the UE itself or an external Application Function (AF) entity can request the location of the UE to be provided from the network, there is no mechanism to prevent the Location Services (LCS) client (which could be either the UE or the AF entity) from manipulating the result (such as the estimate of the location of the UE, the point in time for when the estimate of the location was made, an identifier of the UE, etc.) received from the network.

### SUMMARY

An object of embodiments herein is to address the above issues.

A particular object of embodiments herein is to enable the location of the UE to be verifiable.

According to a first aspect there is presented a method for verifiable location estimation of a UE. The method is performed by the UE. The method comprises determining a first estimate of the location of the UE. The method comprises providing a request to a serving mobile network for the serving mobile network to forward the first estimate to an AF entity. The method comprises receiving a signed token from the AF entity. The signed token comprises either a second estimate of the location of the UE as determined by the serving mobile network in response to an MT-LR having been triggered by the AF entity or the first estimate of the location. The method comprises storing the signed token.

According to a second aspect there is presented a UE for verifiable location estimation. The UE comprises processing circuitry. The processing circuitry is configured to cause the UE to determine a first estimate of the location of the UE. The processing circuitry is configured to cause the UE to provide a request to a serving mobile network for the serving mobile network to forward the first estimate to an AF entity. The processing circuitry is configured to cause the UE to receive a signed token from the AF entity. The signed token comprises either a second estimate of the location of the UE as determined by the serving mobile network in response to an MT-LR having been triggered by the AF entity or the first estimate of the location. The processing circuitry is configured to cause the UE to store the signed token.

According to a third aspect there is presented a computer program for verifiable location estimation of a UE. The computer program comprises computer code which, when run on processing circuitry of the UE, causes the UE to determine a first estimate of the location of the UE. The computer program comprises computer code which, when run on processing circuitry of the UE, causes the UE to provide a request to a serving mobile network for the serving mobile network to forward the first estimate to an AF entity. The computer program comprises computer code which, when run on processing circuitry of the UE, causes the UE to receive a signed token from the AF entity. The signed token comprises either a second estimate of the location of the UE as determined by the serving mobile network in response to an MT-LR having been triggered by the AF entity or the first estimate of the location. The computer program comprises computer code which, when run on processing circuitry of the UE, causes the UE to store the signed token.

According to a fourth aspect there is presented a method for providing a verifiable location estimation of a UE. The method is performed by an AF entity operatively connected to a serving mobile network of the UE. The method comprises obtaining a first estimate of the location of the UE. The first estimate is determined by the UE and is obtained from the serving mobile network of the UE. The method comprises sending an MT-LR for the UE towards the serving mobile network. The MT-LR is triggered by the first estimate having been obtained. The method comprises obtaining a second estimate of the location of the UE from the serving mobile network in a response to the MT-LR. The method comprises sending a signed token towards the UE, only when the second estimate differs less than an error margin from the first estimate. The signed token comprises either the second estimate or the first estimate.

According to a fifth aspect there is presented an AF entity for providing a verifiable location estimation of a UE. The AF entity is configured to be operatively connected to a serving mobile network of the UE. The AF entity comprises processing circuitry. The processing circuitry is configured to cause the AF entity to obtain a first estimate of the location of the UE. The first estimate is determined by the UE and is obtained from the serving mobile network of the UE. The processing circuitry is configured to cause the AF entity to send an MT-LR for the UE towards the serving mobile network. The MT-LR is triggered by the first estimate having been obtained. The processing circuitry is configured to cause the AF entity to obtain a second estimate of the location of the UE from the serving mobile network in a response to the MT-LR. The processing circuitry is configured to cause the AF entity to send a signed token towards the UE only when the second estimate differs less than an error margin from the first estimate. The signed token comprises either the second estimate or the first estimate.

According to a sixth aspect there is presented a computer program for providing a verifiable location estimation of a UE. The computer program comprises computer code which, when run on processing circuitry of an AF entity configured to be operatively connected to a serving mobile network of the UE, causes the AF entity to obtain a first estimate of the location of the UE. The first estimate is determined by the UE and is obtained from the serving mobile network of the UE. The computer program comprises computer code which, when run on processing circuitry of the AF entity, causes the AF entity to send an MT-LR for the UE towards the serving mobile network. The MT-LR is triggered by the first estimate having been obtained. The computer program comprises computer code which, when run on processing circuitry of the AF entity, causes the AF entity to obtain a second estimate of the location of the UE from the serving mobile network in a response to the MT-LR. The computer program comprises computer code which, when run on processing circuitry of the AF entity, causes the AF entity to send a signed token towards the UE, only when the second estimate differs less than an error margin from the first estimate. The signed token comprises either the second estimate or the first estimate.

According to a seventh aspect there is presented a method for verifying a location of a UE. The method is performed by a verifying entity. The method comprises requesting the UE and an AF entity to provide the location of the UE. The method comprises receiving a first response from the UE and a second response from the AF entity. The first response comprises a signed token from the AF entity. The signed token comprises an estimate of the location of the UE as determined by either the AF or the UE and a first hash of the signed token. The estimate originates from either an MO-LR or an MT-LR triggered by the UE. The second response comprises a second hash of the signed token. The method comprises verifying the location of the UE when the second hash equals the first hash.

According to an eighth aspect there is presented a verifying entity for verifying a location of a UE. The verifying entity comprises processing circuitry. The processing circuitry is configured to cause the verifying entity to request the UE and an AF entity to provide the location of the UE. The processing circuitry is configured to cause the verifying entity to receive a first response from the UE and a second response from the AF entity. The first response comprises a signed token from the AF entity and a first hash of the signed token. The signed token comprises an estimate of the location of the UE as determined by either the AF or the UE. The estimate originates from either an MO-LR or an MT-LR triggered by the UE. The second response comprises a second hash of the signed token. The processing circuitry is configured to cause the verifying entity to verify the location of the UE when the second hash equals the first hash.

According to a tenth aspect there is presented a computer program for verifying a location of a UE. The computer program comprises computer code which, when run on processing circuitry of a verifying entity, causes the verifying entity to request the UE and an AF entity to provide the location of the UE. The computer program comprises computer code which, when run on processing circuitry of the verifying entity, causes the verifying entity to receive a first response from the UE and a second response from the AF entity. The first response comprises a signed token from the AF entity. The signed token comprises an estimate of the location of the UE as determined by either the AF or the UE and a first hash of the signed token. The estimate originates from either an MO-LR or an MT-LR triggered by the UE. The second response comprises a second hash of the signed token. The computer program comprises computer code which, when run on processing circuitry of the verifying entity, causes the verifying entity to verify the location of the UE when the second hash equals the first hash.

According to an eleventh aspect there is presented a computer program product comprising a computer program according to at least one of the third aspect, the sixth aspect, and the tenth aspect and a computer readable storage medium on which the computer program is stored. The computer readable storage medium can be a non-transitory computer readable storage medium.

Advantageously, these aspects do not suffer from the above issues.

Advantageously, these aspects prevent the possibility to manipulate the result (such as the estimate of the location of the UE, the point in time for when the estimate of the location was made, an identifier of the UE, etc.) of the location determination for the UE.

Advantageously, these aspects therefore enable the location of the UE to be verifiable.

Advantageously, these aspects provide a trustworthy and verifiable way provide credible location data for the UE at any given point in time.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a network according to embodiments;

FIGS. 2, 3, and 4 are flowcharts of methods according to embodiments;

FIGS. 5 and 6 are signalling diagrams according to embodiments;

FIG. 7 is a schematic diagram showing functional units of a UE according to an embodiment;

FIG. 8 is a schematic diagram showing functional modules of a UE according to an embodiment;

FIG. 9 is a schematic diagram showing functional units of an AF entity according to an embodiment;

FIG. 10 is a schematic diagram showing functional modules of an AF entity according to an embodiment;

FIG. 11 is a schematic diagram showing functional units of a verifying entity according to an embodiment;

FIG. 12 is a schematic diagram showing functional modules of a verifying entity according to an embodiment; and

FIG. 13 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item or piece of information is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item or piece of information is provided by a first device to a second device should be construed as that data item or piece of information being sent or otherwise made available to the second device by the first device. For example, the data item or piece of information might either be pushed to the second device from the first device or pulled by the second device from the second device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

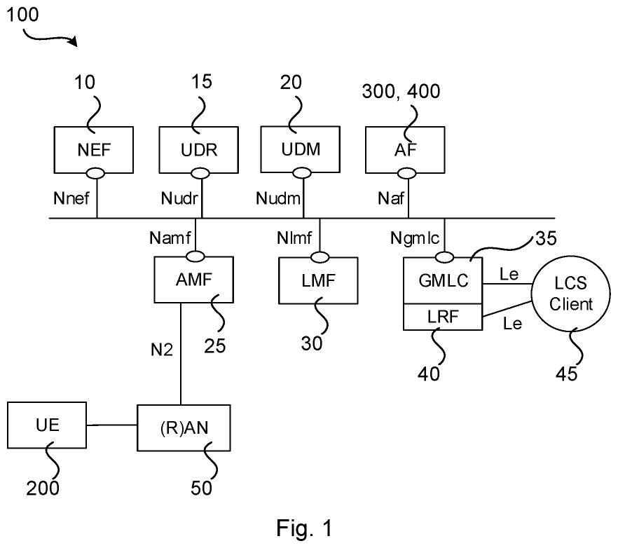

FIG. 1 is a schematic diagram illustrating communication network 100. The communication network 100 might be regarded as a public land mobile network (PLMN) and represents part of a reference architecture of a 5GS and comprises the following entities: a Network Exposure Function (NEF) entity 10, a Unified Data Repository (UDR) entity 15, a Unified Data Manager (UDM) entity 20, an Application Function (AF) entity 300, an Access and Mobility Management Function (AMF) entity 25, a Location Management Function (LMF) entity 30, a Gateway Mobile Location Centre (GMLC) entity 35, a Location Retrieval Function (LRF) entity 40, a Location Services (LCS) Client 45, a UE 200, and a (Radio) Access Network ((R)AN) 50. Service based interfaces are represented by the format Nxyz (e.g., Nnef, Nudr, etc.) and point to point interfaces are represented by the format Nx (e.g., N1, etc.).

The LMF entity 30 manages the overall co-ordination and scheduling of resources required for the location of a UE 200 that is registered with or accessing the 5G CN. It also calculates or verifies a final location and any velocity estimate and may estimate the achieved accuracy. The LMF entity 30 receives location requests for a target UE 200 from the serving AMF entity 25 using the Nlmf interface. The LMF entity 30 interacts with the UE 200 in order to exchange location information applicable to UE assisted and UE based position methods and interacts with the (R)AN 50 in order to obtain location information. In short, the LMF entity 30 thus coordinates UE location determination, ensures relevant measurements are in place and computes location for network based methods.

The GMLC entity 35 is the first node an external LCS client 45 accesses in a PLMN (i.e., the Le reference point is supported by the GMLC entity 35). AF entities 300 and Network Functions (NFs) may access the GMLC entity 35 directly or via the NEF entity 10. The GMLC entity 35 may request routing information and/or target UE privacy information from the UDM entity 20 via the Nudm interface. After performing authorization of an external LCS Client 45 or AF entity 300 and verifying target UE privacy, the GMLC entity 35 forwards a location request to either a serving AMF entity 25 using the Namf interface or to a GMLC entity in another PLMN using the Ngmlc interface in the case of a roaming UE 200. In short, the GMLC entity 35 enables an external request of location to be fulfilled, based on checks the request is either forwarded to a serving AMF entity 25 within the PLMN or to a GMLC entity in another PLMN where that GMLC entity finds the serving AMF entity 25 and the location request can be fulfilled. The latter is in the case of roaming.

The LRF entity 40 may be collocated with the GMLC entity 35 or separate and is responsible for retrieving or validating location information, providing routing and/or correlation information for a UE 200 which has initiated an Internet Protocol Multimedia Subsystem (IMS) emergency session, or the like.

The LCS Client 45 interacts with the GMLC entity 35 for the purpose of obtaining location information for one or more UEs 200. The LCS Client 45 may reside in the UE or in an instance of the AF entity 300 implementing a verifying entity 400.

In some examples, the AF entity 300 holds a signed Service Level Agreement (SLA) with the network 100 that allows the AF entity 300 to use location services offered by other entities in the network 100. In some examples, the AF entity 300 holds subscription specific SLAs regarding which UEs 200 the AF entity 300 is allowed to request location services for. Depending on the SLA(s), the AF entity 300 might be deployed either within or outside the trusted domain of the network 100. The AF entity 300 might belong to a mobile network operator (MNO).

It is noted that although a single occurrence of each entity is illustrated in FIG. 1, there might be two or more instants of some of the entities, such as (but not limited to) the AF entity 300. In this respect, one instant of the AF entity might represent, or implement, or host, a verifying entity 400. As is further understood, there might be more than one (R)AN 75 and a plurality of UEs 200 might be served by the network 100. For illustrative examples, the network 100 will below be referred to as the serving mobile network 100 for the UE 200.

In the present disclosure is disclosed techniques relating to verifiable location estimation of a UE 200. In order to obtain such techniques there is provided a UE 200, a method performed by the UE 200, a computer program product comprising code, for example in the form of a computer program, that when run on processing circuitry of the UE 200, causes the UE 200 to perform the method. In order to obtain such techniques there is further provided an AF entity 300, a method performed by the AF entity 300, and a computer program product comprising code, for example in the form of a computer program, that when run on processing circuitry of the AF entity 300, causes the AF entity 300 to perform the method. In order to obtain such techniques there is further provided a verifying entity 400, a method performed by the verifying entity 400, and a computer program product comprising code, for example in the form of a computer program, that when run on processing circuitry of the verifying entity 400, causes the verifying entity 400 to perform the method.

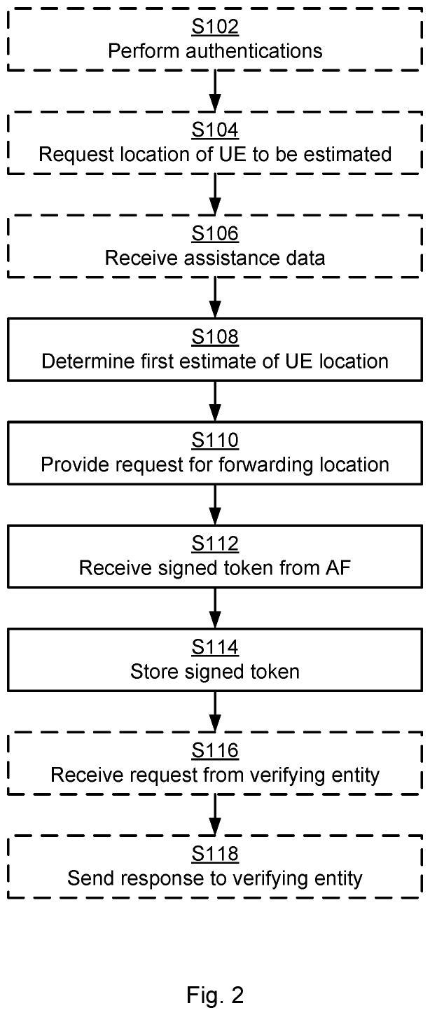

Reference is now made to FIG. 2 illustrating a method for verifiable location estimation of a UE 200 as performed by the UE 200 according to an embodiment.
S108: The UE 200 determines a first estimate of the location of the UE 200.
S110: The UE 200 providing S110 a request to a serving mobile network 100 for the serving mobile network 100 to forward the first estimate to an AF entity 300.
S112: The UE 200 receiving a signed token from the AF entity 300. The signed token comprises either a second estimate of the location of the UE 200 as determined by the serving mobile network 100 in response to an MT-LR having been triggered by the AF entity 300 or the first estimate of the location.
S114: The UE 200 stores the signed token.

Embodiments relating to further details of verifiable location estimation of the UE 200 as performed by the UE 200 will now be disclosed.

In some aspects, the signed token is only stored if the location as provided in the signed token corresponds to the location as estimated in step S108. Therefore, in some embodiments, it is verified by the UE 200 that the second estimate differs less than an error margin from the first estimate before the signed token is stored.

In some aspects, the UE 200 performs primary authentication towards the serving mobile network 100 and then consequently performs secondary authentication towards the AF entity 300. Hence in some embodiments, the UE 200 is configured to perform (optional) step S102.

S102: The UE 200 performing S102 primary authentication with the serving mobile network 100 and secondary authentication with the AF entity 300 before providing the request to the serving mobile network 100.

In some aspects, the first estimate of the location as determined in step S108 is obtained without using any dedicated support data from the serving mobile network 100. In this respect, the UE 200 might determine the estimate from cell information as received from the serving mobile network, from internal sensors (such as a positioning sensor), or the like, for example depending on the level of granularity of which the location is to be estimated. In other aspects, the first estimate of the location as determined in step S108 is obtained based on support data from the serving mobile network 100. Hence in some embodiments, the UE 200 is configured to perform (optional) step S104 and (optional) step S106.
S104: The UE 200 requesting S104, by triggering an MO-LR towards the serving mobile network 100, a location of the UE 200 to be estimated.
S106: The UE 200, in response thereto, receives assistance data from the serving mobile network 100. The first estimate of the location is then determined also based on the assistance data.

The assistance data might be positioning reference signals, or other positioning indicating, or aiding, information.

There could be further information provided in the signed token. In this respect, in some examples, the signed token further comprises a timestamp and an identifier of the UE 200. The identifier could be one of the Generic Public Subscription Identifiers (GPSIs) belonging to the UE 200.

In some aspects, at a later time when the UE 200 has to provide proof of where it has been located, the UE 200 can present the signed token. In particular, in some embodiments, the UE 200 is configured to perform (optional) step S116 and (optional) step S118.
S116: The UE 200 receives a request from a verifying entity 400 to verify the location of the UE 200. In response thereto
S118: The UE 200 sends a response to the verifying entity 400. The response comprises the signed token and (optionally) a hash of the signed token.

Further in this respect, as an additional step to provide more trust, the UE 200 might compute a chain of hashes to enable the verifying entity 400 to ensure that neither UE 200 nor the AF entity 300 has altered the signed token. Hence, in some embodiments, when a set of locations of the UE 200 is estimated, there is one signed token per each of the locations and a respective hash is computed for each of the locations. The request is for the set of locations. The response sent to the verifying entity 400 comprises a chain of the hashes and the signed tokens for the set of locations.

To illustrate this, let Hx and Tokenx, where x=1, 2, . . . , denote different hashes and tokens, respectively, and let Ø denote the empty set. Then:

$${H}_{1} = Hash ( {Token}_{1} \vert ∅ ) ,$$

$${H}_{2} = Hash ( {Token}_{2} \vert {H}_{1} ) ,$$

$${H}_{3} = Hash ( {Token}_{3} \vert {H}_{2} ) ,$$

$$…$$

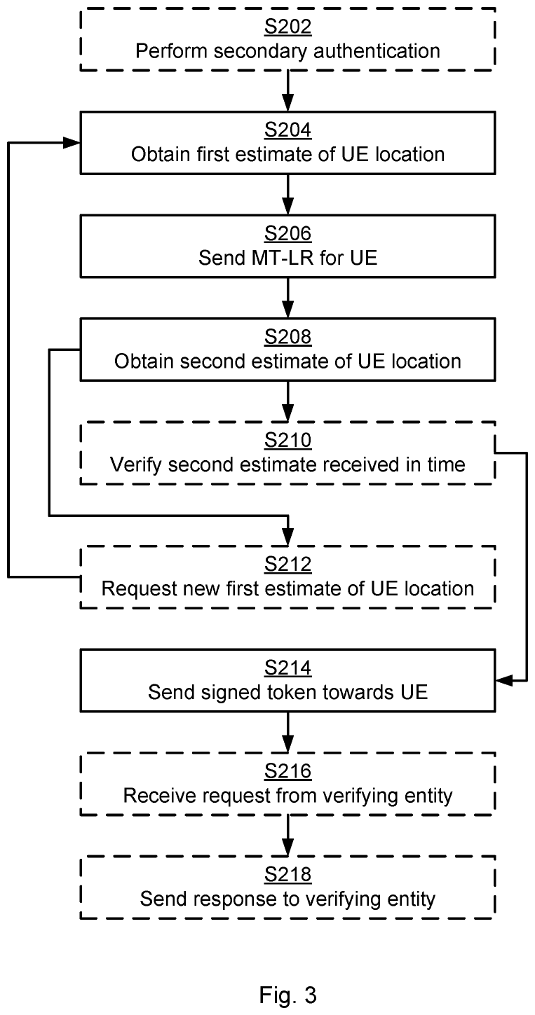

Reference is now made to FIG. 3 illustrating a method for providing a verifiable location estimation of a UE 200 as performed by the AF entity 300 according to an embodiment. The AF entity 300 is configured to be operatively connected to the serving mobile network 100 of the UE 200 when the method is performed.
S204: The AF entity 300 obtains a first estimate of the location of the UE 200. The first estimate is determined by the UE 200. The first estimate is by the AF node 300 obtained from the serving mobile network 100 of the UE 200.
S206: The AF entity 300 sends an MT-LR for the UE 200 towards the serving mobile network 100. The MT-LR is triggered by the AF entity 300 having obtained the first estimate.
S208: The AF entity 300 obtains a second estimate of the location of the UE 200 from the serving mobile network 100. The second estimate is obtained in a response to the AF entity 300 having sent the MT-LR.
S214: The AF entity 300 sends a signed token towards the UE 200, only when the second estimate differs less than an error margin from the first estimate. The signed token comprises either the second estimate or the first estimate.

Embodiments relating to further details of providing a verifiable location estimation of the UE 200 as performed by the AF entity 300 will now be disclosed.

As disclosed above, in some aspects, the UE 200 performs secondary authentication towards the AF entity 300. Hence in some embodiments, the AF entity 300 is configured to perform (optional) step S202.

S202: The AF entity 300 performs secondary authentication with the UE 200 before the first estimate is obtained.

As disclosed above, there could be further information provided in the signed token. In this respect, in some examples, the signed token further comprises a timestamp and an identifier of the UE 200. As above, the identifier could be one of the GPSIs belonging to the UE 200.

In some aspects, the AF entity 300 verifies that not too much time has elapsed between reception of the two estimates. In particular, in some embodiments, the AF entity 300 is configured to perform (optional) step S210.

S210: The AF entity 300 verifies that the second estimate was obtained within a predetermined time window of the first estimate. This verification is performed before the AF entity 300 sends the signed token.

In some aspects, in case the result is outside of an acceptable error margin the AF entity 300 requests the UE 200 to perform a new estimation of its location, possible using a different mode of determining the location. In particular, in some embodiments, the AF entity 300 is configured to perform (optional) step S212 before sending the signed token.

S212: The AF entity 300 requests the UE 200 to send a new first estimate of the location of the UE 200. The reception of the new first estimate by the AF entity 300 (corresponding to step S204 but with the new first estimate) triggers the AF entity 300 to trigger a new MT-LR (corresponding to step S206).

Step S212 might by the AF node 300 performed when the AF node 300 fails to verify that the second estimate was obtained within a predetermined time window of the first estimate. Further in this respect, the request sent in step S212 might pass through the serving mobile network 100 before reaching the UE 200. Still further in this respect, the UE 200 might start a timer when the first estimate is sent in S110.

Then, if the timer expires before the UE 200 receives any signed token from the AF, the UE 200 could trigger a new MO-LR.

In some aspects, at a later time when the AF entity 300 has to provide proof of where UE 200 has been located, the AF entity 300 can present the signed token. In particular, in some embodiments, the AF entity 300 is configured to perform (optional) step S216 and (optional) step S218.
S216: The AF entity 300 receives a request from a verifying entity 400 to verify the location of the UE 200.
S218: The AF entity 300, in response thereto, sends a response to the verifying entity 400. The response comprises a hash of the signed token.

Further in this respect, as an additional step to provide more trust, the AF entity 300 might compute a chain of hashes to enable the verifying entity 400 to ensure that neither the AF entity 300 nor the UE 200 has altered the signed token, and/or that any token has not been left out of the set of tokens provided to the verifying entity 400. Hence, in some embodiments, when a set of locations of the UE 200 is estimated, there is one signed token per each of the locations and a respective hash is computed for each of the locations. The request is for the set of locations. The response sent to the verifying entity 400 comprises a chain of the hashes for the set of locations.

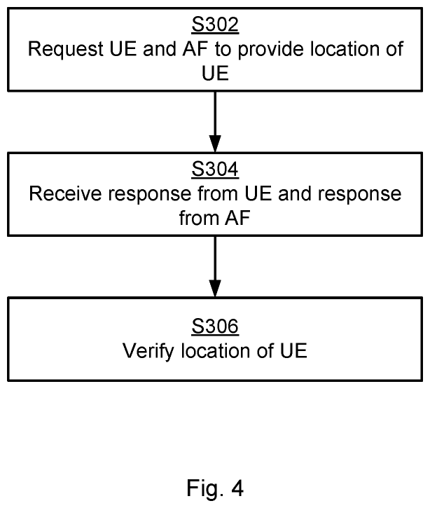

Reference is now made to FIG. 4 illustrating a method for verifying a location of a UE 200 as performed by the verifying entity 400 according to an embodiment.
S302: The verifying entity 400 requests the UE 200 and the AF entity 300 to provide the location of the UE 200.
S304: The verifying entity 400 receives a first response from the UE 200 and a second response from the AF entity 300. The first response comprises a signed token from the AF entity 300 and a first hash of the signed token. The signed token comprises an estimate of the location of the UE 200 as determined by either the AF or the UE 200. When the estimate is determined by the UE 200, the estimate originates from an MO-LR. When the estimate is determined by the AF entity 300, the estimate originates from an MT-LR triggered by the UE 200. The second response comprises a second hash of the signed token.
S306: The verifying entity 400 verifies the location of the UE 200 when the second hash equals the first hash.

Embodiments relating to further details of verifying a location of the UE 200 as performed by the verifying entity 400 will now be disclosed.

As disclosed above, there could be further information provided in the signed token. In this respect, in some examples, the signed token further comprises a timestamp and an identifier of the UE 200. The identifier could be one of the GPSIs belonging to the UE 200.

As disclosed above, as an additional step to provide more trust, the UE 200 and the AF entity 300 might each compute a respective chain of hashes to enable the verifying entity 400 to ensure that neither the UE 200 nor the AF entity 300 has altered the signed token and/or left any token out of the set of tokens provided to the verifying entity 400. Hence, in some embodiments the request is for a set of locations of the UE 200. The first response then comprises a chain of first hashes for the set of locations and one signed token per each of the locations. The second response then comprises a chain of second hashes for the set of locations.

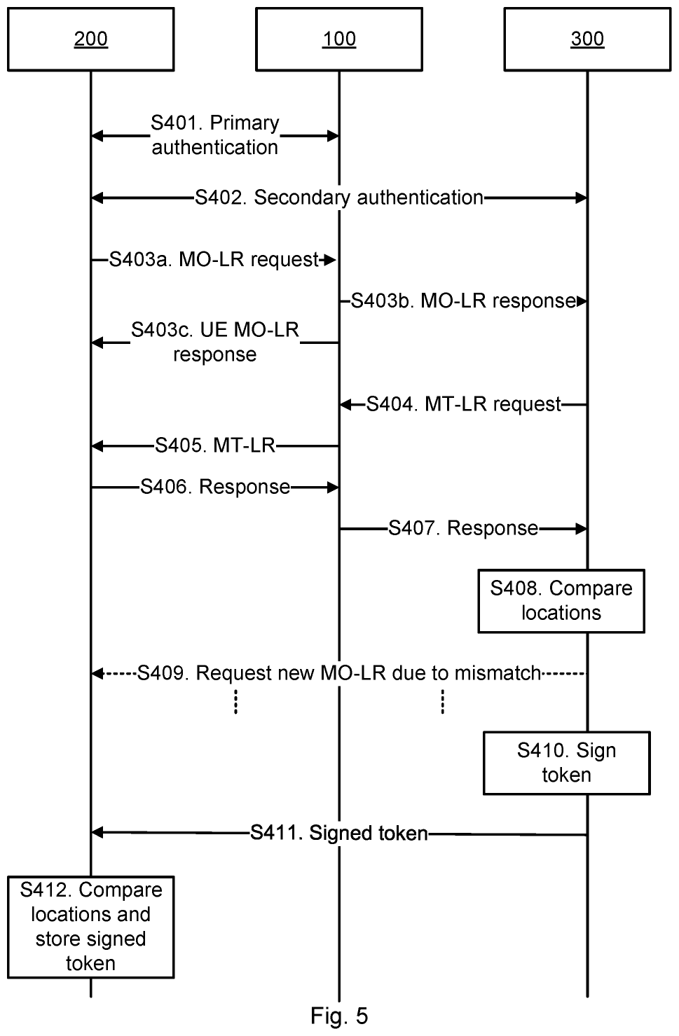

One particular embodiment for enabling a UE 200 to obtain a verifiable location estimation will now be disclosed with reference to the signalling diagram of FIG. 5.
S400: (not in the figure) UDM entity 35 in the network 100 is provisioned with information of which Subscription Permanent Identifiers (SUPIs) that are authorized to connect to, and subject to secondary authentication (or slice specific authentication) for connecting to AF entity 300.
S401: UE 200 registers to the network 100 and performs primary authentication as specified in 3GPP TS 33.501 version 17.5.0. UE 200 requests a protocol data unit (PDU) session or slice for interconnecting with AF entity 300. UDM entity 35 checks the SUPI of UE 200 in order to verify that the PDU session request for AF entity 300 is valid.
S402: UE 200 performs secondary (or slice) authentication as specified in 3GPP TS 33.501 version 17.5.0 with AF entity 300. The choice of credentials to use during the secondary authentication is determined by AF entity 300 as long as its compliant and compatible with the Extensible Authentication Protocol (EAP) framework. During the authentication, the network 100 provides one of the GPSIs belonging to UE 200 to AF entity 300.
S403a: UE 200 intends to obtain a first estimate of its location. UE 200 operates in standalone mode, or in network-assisted mode. Measurements needed for UE 200 to estimate of its location are therefore made by UE 200 either on signals received from the network 100 or based on internal sensors, such as positioning sensors. UE sends an MO-LR request as specified in clause 6.2 of aforementioned document 3GPP TS 23.273, where the MO-LR request comprises the first estimate of the location of UE 200. The network 100 thereby obtains the first estimate of the location of UE 200.
S403b. The MO-LR response comprising the first estimate of the location of UE 200 is forwarded to AF entity 300. AF entity 300 thereby obtains the first estimate of the location of UE 200.
S403c: The MO-LR response is returned to UE 200. UE 200 thereby obtains an acknowledgement that the first estimate of its location has been forwarded to the network 100.
S404: AF entity 300 intends to obtain a second estimate of the location of UE 200 and therefore sends an MT-LR request as specified in clause 6.1.2 of aforementioned document 3GPP TS 23.273 with the GPSI of UE 200 as identifier.
S405: Location services are performed in network 100 as specified in clause 6.1.2 of aforementioned document 3GPP TS 23.273, operating in network-based mode.
S406: UE 200 transmits signals towards the network 100. The signals transmitted by UE 200 constitutes a response to the location request. However, that the use of the signals transmitted by the UE is for network-based mode is transparent to UE 200 to minimize the risk of UE 200 providing altered information that could impact the estimation. The network 100 from measurements on the signals obtains a second estimate of the location of UE 200. In some aspects, the first estimate and the second estimate are thereby determined using mutually different techniques for estimating the location of the UE 200. This might increase the protection against a possible attacker (such as an entity having control of one of the UE 200 and the AF entity 300 but not both) to spoof the location of the UE 200.
S407: The response, including the second estimate of the location of UE 200 is, together with the GPSI, forwarded to AF entity 300. AF entity 300 thereby obtains the second estimate of the location of UE 200.
S408: AF entity 300 now possesses two recent estimates (i.e., the first estimate and the second estimate) of the location for UE 200 as identified by GPSI. AF entity 300 compares the two estimates and decides whether the estimates differ at most within a given error margin from each other or not. If the comparison is successful, AF entity 300 generates a token. The token comprises either the first estimate or the second estimate of the location, a timestamp and a unique identifier of UE 200 (and possibly other relevant data). The unique identifier might be the GPSI. Step S410 is then entered. If the comparison is not successful, step S409 is entered.
S409: Optionally, in case the estimates differ more than the given error margin from each other, e.g., there is too long time in between the two estimates or the estimated locations differ too much from each other, AF entity 300 requests UE 200 to perform another MO-LR, and hence step S403a is entered again. This communication is performed over the established PDU session.
S410: AF entity 300 sends the signed token to UE 200.
S411: UE 200 stores the received signed token. Optionally, UE 200 verifies that the signed token comprises a correct location, for example by comparing the location comprises in the signed token to the first estimate of the location as obtained in step S403a.

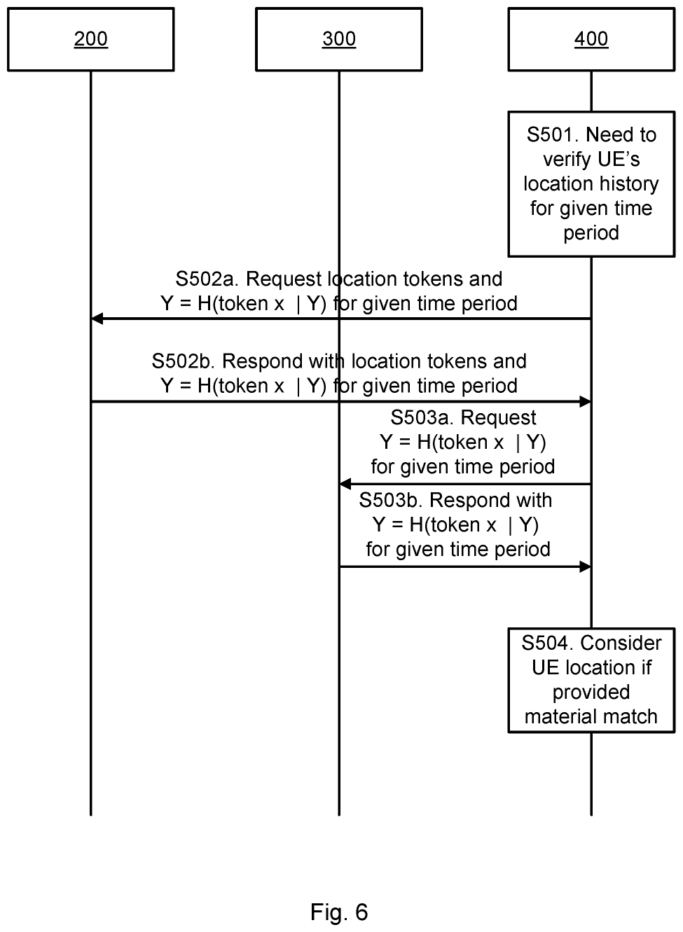

One particular embodiment for a verifying entity 400 to verify the location of a UE 200 will now be disclosed with reference to the signalling diagram of FIG. 6. In general terms, in order to achieve this, the verifying entity 400 communicates with the AF entity 300 and the UE 200 in order to establish if the location of the UE 200 for a given time is trustworthy.
S501: Verifying entity 400 wishes to verify that the location history of UE 200 is accurate.
S502a. Verifying entity 400 requests location information of UE 200 from UE 200.
S502b: UE 200 responds with hashes and/or location tokens corresponding to the location history of UE 200. A chain of hashed tokens might be calculated by UE 200 as disclosed above.
S503a. Verifying entity 400 requests location information of UE 200 from AF entity 300.
S503b. AF entity 300 responds with hashes corresponding to the location history of UE 200. A chain of hashed tokens might be calculated by AF entity 300 as disclosed above.
S504: Verifying entity 400 compares the location information in terms of hashes and/or location tokens received from UE 200 to the location information in terms of hashes received from AF entity 300 and ensures that the hashes with corresponding timestamps match each other. Optionally, verifying entity 400 additionally calculates the same chain of hashed tokens with the provided location tokens from UE 200. Verifying entity 400 can then be certain that the provided location tokens have in fact been verified by AF entity 300.

There could be different scenarios where the location (either a single location for a single point in time, or a history of locations, each for its own point in time) needs to be verified. In some non-limiting examples, the herein disclosed embodiments are applied to prove that the UE 200 has visited a certain location at a certain point in time. This can be useful for a security guard carrying the UE 200 to prove that the security guard has visited a certain security object at a certain point in time. However, in other non-limiting examples, the herein disclosed embodiments are applied to rule out that the UE 200 has visited a certain location at a certain point in time. This can be useful for a person to prove that the person has not visited a certain area of danger, or other area which should be avoided or which the person is not even allowed to visit, at a certain point in time.

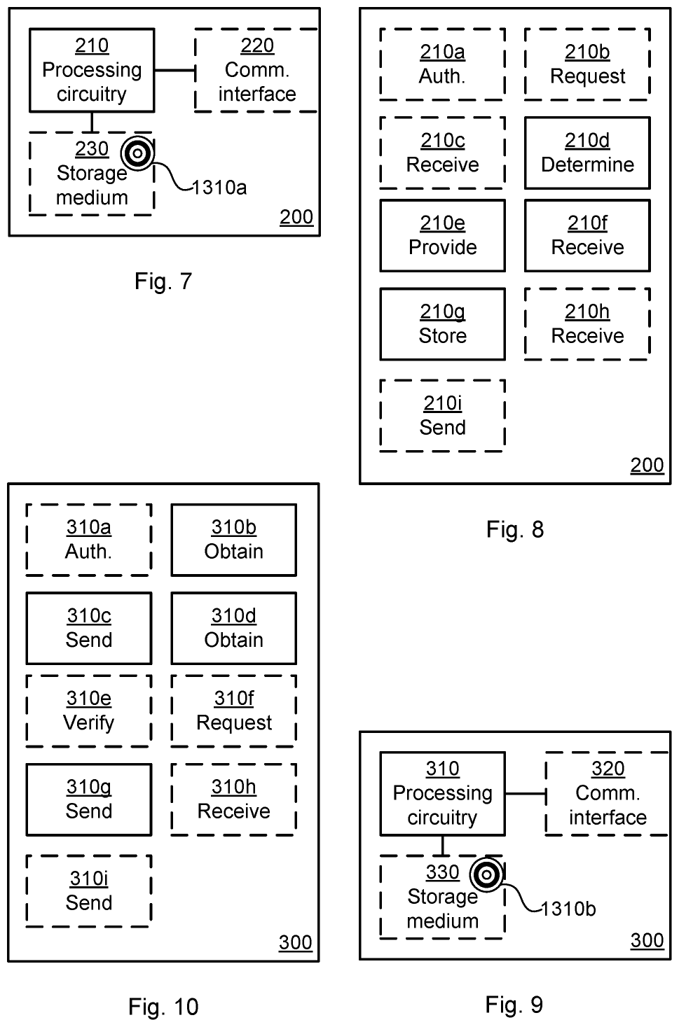

FIG. 7 schematically illustrates, in terms of a number of functional units, the components of a UE 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the UE 200 to perform a set of operations, or steps, as disclosed above. For example, the storage medium 230 may store the set of operations, and the processing circuitry 210 may be configured to retrieve the set of operations from the storage medium 230 to cause the UE 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The UE 200 may further comprise a communications interface 220 for communications with other entities, functions, nodes, and devices, as illustrated in FIG. 1. As such the communications interface 220 may comprise one or more transmitters and receivers, comprising analogue and digital components.

The processing circuitry 210 controls the general operation of the UE 200 e.g. by sending data and control signals to the communications interface 220 and the storage medium 230, by receiving data and reports from the communications interface 220, and by retrieving data and instructions from the storage medium 230. Other components, as well as the related functionality, of the UE 200 are omitted in order not to obscure the concepts presented herein.

FIG. 8 schematically illustrates, in terms of a number of functional modules, the components of a UE 200 according to an embodiment. The UE 200 of FIG. 8 comprises a number of functional modules; a determine module 210d configured to perform step S108, a provide module 210e configured to perform step S110, a receive module 210f configured to perform step S112, and a store module 210g configured to perform step S114. The UE 200 of FIG. 8 may further comprise a number of optional functional modules, such as any of an authentication module 210a configured to perform step S102, a request module 210b configured to perform step S104, a receive module 210c configured to perform step S106, a receive module 210h configured to perform step S116, and a send module 210i configured to perform step S118.

In general terms, each functional module 210a: 210i may be implemented in hardware or in software. Preferably, one or more or all functional modules 210a: 210i may be implemented by the processing circuitry 210, possibly in cooperation with the communications interface 220 and the storage medium 230. The processing circuitry 210 may thus be arranged to from the storage medium 230 fetch instructions as provided by a functional module 210a: 210i and to execute these instructions, thereby performing any steps of the UE 200 as disclosed herein.

FIG. 9 schematically illustrates, in terms of a number of functional units, the components of an AF entity 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the AF entity 300 to perform a set of operations, or steps, as disclosed above. For example, the storage medium 330 may store the set of operations, and the processing circuitry 310 may be configured to retrieve the set of operations from the storage medium 330 to cause the AF entity 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The AF entity 300 may further comprise a communications interface 320 for communications with other entities, functions, nodes, and devices, as illustrated in FIG. 1. As such the communications interface 320 may comprise one or more transmitters and receivers, comprising analogue and digital components.

The processing circuitry 310 controls the general operation of the AF entity 300 e.g. by sending data and control signals to the communications interface 320 and the storage medium 330, by receiving data and reports from the communications interface 320, and by retrieving data and instructions from the storage medium 330. Other components, as well as the related functionality, of the AF entity 300 are omitted in order not to obscure the concepts presented herein.

FIG. 10 schematically illustrates, in terms of a number of functional modules, the components of an AF entity 300 according to an embodiment. The AF entity 300 of FIG. 10 comprises a number of functional modules; an obtain module 310b configured to perform step S204, a send module 310c configured to perform step S206, an obtain module 310d configured to perform step S208, and a send module 310g configured to perform step S214. The AF entity 300 of FIG. 10 may further comprise a number of optional functional modules, such as any of an authenticate module 310a configured to perform step S202, a verify module 310e configured to perform step S210, a request module 310f configured to perform step S212, a receive module 310h configured to perform step S216, and a send module 310i configured to perform step S218.

In general terms, each functional module 310a: 310i may be implemented in hardware or in software. Preferably, one or more or all functional modules 310a: 310i may be implemented by the processing circuitry 310, possibly in cooperation with the communications interface 320 and the storage medium 330. The processing circuitry 310 may thus be arranged to from the storage medium 330 fetch instructions as provided by a functional module 310a: 310i and to execute these instructions, thereby performing any steps of the AF entity 300 as disclosed herein.

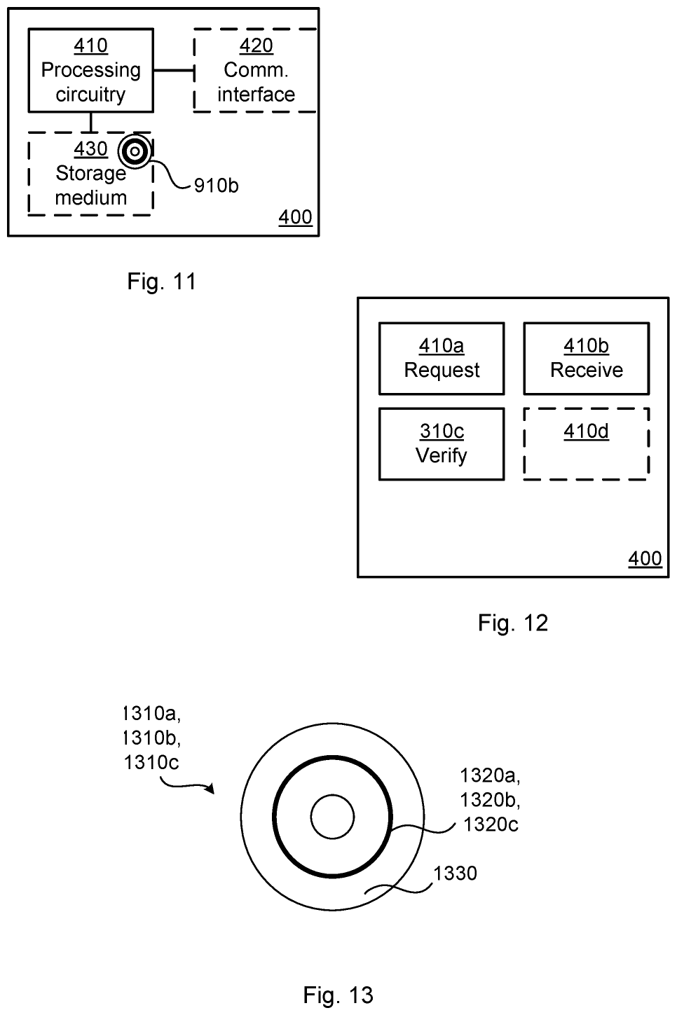

FIG. 11 schematically illustrates, in terms of a number of functional units, the components of a verifying entity 400 according to an embodiment. Processing circuitry 410 is provided using any combination of one or more of a suitable central processing unit (CPU), multiprocessor, microcontroller, digital signal processor (DSP), etc., capable of executing software instructions stored in a computer program product 1310c (as in FIG. 13), e.g. in the form of a storage medium 430. The processing circuitry 410 may further be provided as at least one application specific integrated circuit (ASIC), or field programmable gate array (FPGA).

Particularly, the processing circuitry 410 is configured to cause the verifying entity 400 to perform a set of operations, or steps, as disclosed above. For example, the storage medium 430 may store the set of operations, and the processing circuitry 410 may be configured to retrieve the set of operations from the storage medium 430 to cause the verifying entity 400 to perform the set of operations. The set of operations may be provided as a set of executable instructions. Thus the processing circuitry 410 is thereby arranged to execute methods as herein disclosed.

The storage medium 430 may also comprise persistent storage, which, for example, can be any single one or combination of magnetic memory, optical memory, solid state memory or even remotely mounted memory.

The verifying entity 400 may further comprise a communications interface 420 for communications with other entities, functions, nodes, and devices, as illustrated in FIG. 1. As such the communications interface 420 may comprise one or more transmitters and receivers, comprising analogue and digital components.

The processing circuitry 410 controls the general operation of the verifying entity 400 e.g. by sending data and control signals to the communications interface 420 and the storage medium 430, by receiving data and reports from the communications interface 420, and by retrieving data and instructions from the storage medium 430. Other components, as well as the related functionality, of the verifying entity 400 are omitted in order not to obscure the concepts presented herein.

FIG. 12 schematically illustrates, in terms of a number of functional modules, the components of a verifying entity 400 according to an embodiment. The verifying entity 400 of FIG. 12 comprises a number of functional modules; a request module 410a configured to perform step S302, a receive module 410b configured to perform step S304, and a verify module 310c configured to perform step S306. The verifying entity 400 of FIG. 12 may further comprise a number of optional functional modules, as represented by functional module 410d. In general terms, each functional module 410a: 410d may be implemented in hardware or in software. Preferably, one or more or all functional modules 410a: 410d may be implemented by the processing circuitry 410, possibly in cooperation with the communications interface 420 and the storage medium 430. The processing circuitry 410 may thus be arranged to from the storage medium 430 fetch instructions as provided by a functional module 410a: 410d and to execute these instructions, thereby performing any steps of the verifying entity 400 as disclosed herein.

FIG. 13 shows one example of a computer program product 1310a, 1310b, 1310c comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the UE 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the AF entity 300 as herein disclosed. On this computer readable means 1330, a computer program 1320c can be stored, which computer program 1320c can cause the processing circuitry 410 and thereto operatively coupled entities and devices, such as the communications interface 420 and the storage medium 430, to execute methods according to embodiments described herein. The computer program 1320c and/or computer program product 1310c may thus provide means for performing any steps of the verifying entity 400 as herein disclosed.

In the example of FIG. 13, the computer program product 1310a, 1310b, 1310c is illustrated as an optical disc, such as a CD (compact disc) or a DVD (digital versatile disc) or a Blu-Ray disc. The computer program product 1310a, 1310b, 1310c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b, 1320c is here schematically shown as a track on the depicted optical disk, the computer program 1320a, 1320b, 1320c can be stored in any way which is suitable for the computer program product 1310a, 1310b, 1310c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for verifiable location estimation of a user equipment (UE), the method being performed by the UE, the method comprising:
determining a first estimate of the location of the UE;
providing a request to a serving mobile network for the serving mobile network to forward the first estimate to an application function (AF) entity;
receiving a signed token from the AF entity, wherein the signed token comprises either a second estimate of the location of the UE as determined by the serving mobile network in response to a Mobile Terminated Location Request (MT-LR) having been triggered by the AF entity or the first estimate of the location; and
storing the signed token.

2. The method of claim 1, wherein it is verified by the UE that the second estimate differs less than an error margin from the first estimate before the signed token is stored.

3. The method of claim 1, wherein the method further comprises:
requesting, by triggering a Mobile Originated Location Request (MO-LR) towards the serving mobile network, a location of the UE to be estimated; and in response thereto:
receiving assistance data from the serving mobile network, and wherein the first estimate of the location further is determined based on the assistance data

4. The method of claim 1, wherein the method further comprises:
performing primary authentication with the serving mobile network and secondary authentication with the AF entity before providing the request to the serving mobile network.

5. The method of claim 1, wherein the signed token further comprises a timestamp and an identifier of the UE.

6. The method of claim 1, wherein the method further comprises:
receiving a request from a verifying entity to verify the location of the UE; and in response thereto:
sending a response to the verifying entity, the response comprising the signed token and a hash of the signed token.

7. (canceled)

8. A method for providing a verifiable location estimation of a user equipment (UE), the method being performed by an application function (AF) entity operatively connected to a serving mobile network of the UE, the method comprising:
obtaining a first estimate of the location of the UE, the first estimate being determined by the UE and obtained from the serving mobile network of the UE;
sending a Mobile Terminated Location Request (MT-LR) for the UE towards the serving mobile network, wherein the MT-LR is triggered by the first estimate having been obtained;
obtaining a second estimate of the location of the UE from the serving mobile network in a response to the MT-LR; and
sending a signed token towards the UE, wherein the signed token comprises either the second estimate or the first estimate, only when the second estimate differs less than an error margin from the first estimate.

9. The method of claim 8, wherein the method further comprises:
performing secondary authentication with the UE before obtaining the first estimate.

10. The method of claim 8, wherein the token further comprises a timestamp and an identifier of the UE.

11. The method of claim 8, wherein the method further comprises:
verifying that the second estimate was obtained within a predetermined time window of the first estimate before sending the signed token.

12. The method of claim 8, wherein, when failing to verify that the second estimate was obtained within a predetermined time window of the first estimate before sending the signed token, the method further comprising:
requesting the UE to send a new first estimate of the location of the UE which triggers the AF entity to trigger a new MT-LR.

13. The method of claim 8, wherein the method further comprises:
receiving a request from a verifying entity to verify the location of the UE; and in response thereto:
sending a response to the verifying entity, the response comprising a hash of the signed token.

14. The method of claim 8, wherein, when a set of locations of the UE is estimated, there is one signed token per each of the locations and a respective hash is computed for each of the locations, wherein the request is for the set of locations, and wherein the response sent to the verifying entity comprises a chain of the hashes for the set of locations.

15. A method for verifying a location of a user equipment (UE), the method being performed by a verifying entity, the method comprising:
requesting the UE and an application function (AF) entity to provide the location of the UE;
receiving a first response from the UE and a second response from the AF entity, wherein the first response comprises a signed token from the AF entity, wherein the signed token comprises an estimate of the location of the UE as determined by either the AF or the UE, and wherein the estimate originates from either a Mobile Originated Location Request (MO-LR) or a Mobile Terminated Location Request (MT-LR) triggered by the UE, and a first hash of the signed token, and wherein the second response comprises a second hash of the signed token; and
verifying the location of the UE when the second hash equals the first hash.

16-17. (canceled)

18. A user equipment (UE) for verifiable location estimation, the UE comprising processing circuitry, the processing circuitry being configured to cause the UE to:
determine a first estimate of the location of the UE;
provide a request to a serving mobile network for the serving mobile network to forward the first estimate to an application function (AF) entity;
receive a signed token from the AF entity, wherein the signed token comprises either a second estimate of the location of the UE as determined by the serving mobile network in response to a Mobile Terminated Location Request (MT-LR) having been triggered by the AF entity or the first estimate of the location; and
store the signed token.

19. An application function (AF) entity for providing a verifiable location estimation of a user equipment (UE), the AF, entity being configured to be operatively connected to a serving mobile network of the UE, the AF entity comprising processing circuitry, the processing circuitry being configured to cause the AF entity to:
perform the method of claim 8.

20. A verifying entity for verifying a location of a user equipment (UE), the verifying entity comprising processing circuitry, the processing circuitry being configured to cause the verifying entity to:
perform the method of claim 15.

21. A non-transitory computer readable storing medium storing a computer program for verifiable location estimation of a user equipment (UE), the computer program comprising computer code which, when run on processing circuitry of the UE, causes the UE to perform the method of claim 1.

22. A non-transitory computer readable storing medium storing a computer program for providing a verifiable location estimation of a user equipment (UE), the computer program comprising computer code which, when run on processing circuitry of an application function (AF) entity configured to be operatively connected to a serving mobile network of the UE, causes the AF entity to perform the method of claim 8.

23. A non-transitory computer readable storing medium storing a computer program for verifying a location of a user equipment (UE), the computer program comprising computer code which, when run on processing circuitry of a verifying entity, causes the verifying entity to perform the method of claim 15.

24. (canceled)
